(19) United States
(12) Patent Application Publication
(10) Pub. No.: US 2010/0006109 A1
(43) Pub. Date: Jan. 14, 2010

(54) VENTILATING MOUTHGUARD DEVICE, KIT AND METHOD OF USING SAME

(76) Inventors: William J. McGinnis, Cincinnati, OH (US); Scott A. METRICK, Glenview, IL (US)

Correspondence Address: LADAS & PARRY LLP, 224 SOUTH MICHIGAN AVENUE, SUITE 1600, CHICAGO, IL, 60604, US

(21) Appl. No.: 12/170,525

(22) Filed: Jul. 10, 2008

(51) Int. Cl. A61C 5/14; A61C 13/00

(52) U.S. Cl. 128/861; 264/16

(57) ABSTRACT

A ventilating mouthguard device, kit and method of using same is presented for use in providing a user an auxiliary boost of air while wearing the mouthguard. The ventilating mouthguard device includes a base plate, an on/off switch, a power supply and a fan. The base plate has an air passageway traversing all the way thought the base plate so that outside air can easily channeled into the mouth of the user. The on/off switch is electrically coupled to the power supply and to the fan. The fan is positioned so that it is in fluid communications within the air passageway in order to push air into the mouth of the user. The kit includes the unconnected components of the ventilating mouthguard device. The method includes the steps of applying, coupling, covering, curing, mixing, mounting, obtaining, preparing, removing, selecting, and turning.

### FIELD OF THE INVENTION

The present invention relates to mouthguards and alike. More particularly to a ventilating mouthguard device configured to provide an auxiliary air flow rate into the mouth of a user.

### BACKGROUND OF THE INVENTION

Mouthguards are well known in athletics, especially in contact sports, such as boxing, rugby, football, martial arts. Mouthguards are even occasionally used in other sports, such as handball, basketball, skiing, tennis, and cycling.

One of the main reason why an athletic individual would want to wear a mouthguard is to significantly reduce the possibility of injury to teeth. Mouthguards aid in minimizing a number of adverse affects that result from sudden impacts delivered at a relatively small surface area in the mouth by distributing the force of the impact over a relatively larger surface area.

Another reasons why an athletic individual would want to wear a mouthguard is also to reduce cranial injuries, e.g. concussions. Mouthguards can cushion the force of an upwardly directed blow administered to the upper set of teeth via an upper impact the lower jaw.

Yet another reason why an athletic individual would also want to wear a mouthguard is to prevent the clenching of their teeth during exertion. Mouthguards can be useful in minimizing the adverse affects associated with the athletic individual unknowingly biting down while performing a particularly difficult physical activity, such as bench pressing weights heavy weights. The physical stress and mental strain associated with pushing one's limits to the maximum can result in result in producing hundreds of pounds of compressed force exerted across the lower jaw onto the upper jaw. This type of unwanted clenching can result in headaches, muscle spasms, tooth damage and temporomandibular joint damage. Accordingly, body builders, weight lifters, baseball batters, golfers, football players, hockey players, and bowlers have been known to wear mouthguard to prevent the unwanted clenching of their teeth.

Mouthguards are also well known in non-athletic scenarios. In particular, mouthguards are known to be a great benefit in various scenarios involving the medical arts. Birthing mothers may benefit from using mouthguards to minimize teeth clenching during child birthing. Patients who undergo minor surgical procedures without any anesthesia may benefit from using mouthguards to prevent the adverse affects of the effects of teeth clenching during these anaesthetized procedures. Patients who grind their teeth while sleeping may also benefit from using mouthguards.

A number of different types of mouthguards are presently known and in use today. One type of mouthguard presently known and in use is a universal mouthguard is intended to be worn as received without changing the mouthguard morphology. These types of mouthguards are typically made of rubber or some other type of plastic and are formed generally to the shape of the upper dental arch and teeth. These mouthguards are relatively inexpensive but they tend to fit loosely and are not retained easily in the mouth. Further, these types of mouthguards are known to be prone to being easily dislodged as a result of the same types of physical blows they were intended to protect.

A second type of mouthguard presently known and in use is a universal blank mouthguard. This type of mouthguard is commonly known as a “boil and bite” type of mouthguard. They are typically made of some type of thermoplastic material capable of being thermally molded and shaped to conform to the dental arch and to the teeth of the individual user. Typically, this type of mouthguard is sold as a blank mouthguard which is subsequently warmed, usually by being dipped in hot water, and then inserted into the mouth of the individual to provide a custom fit against the dental arch and teeth of that individual user.

Another type of mouthguard is a dental impression mouthguard where an impression of the dental arch and/or teeth of the individual is obtained. This type of mouthguard is usually used as a platform for aligning and holding some sort of solidifying agent to obtain a negative impression of the dental arch and/or the teeth.

While such mouthguards have generally good protective and retentive characteristics, they are frequently uncomfortable and can exhaust the wearer by restricting air flow during inhaling/exhaling.

Therefore, a need exists for a new and improved mouthguard device, kit and an associated method of using same for providing the wearer an auxiliary supply of air into the user's mouth. In this respect, the ventilating mouthguard device according to the present invention substantially departs from the conventional concepts and designs of the prior art, and in doing so provides an apparatus primarily developed for the purpose of providing a convenient means for making it possible to breath more easily when wearing a mouthguard.

### SUMMARY OF THE INVENTION

The present ventilating mouthguard device, kit and method of using same, according to the principles of the present invention, overcomes a number of the shortcomings of the prior art by providing a novel ventilating mouthguard device, kit and method for use in providing an auxiliary air flow rate into the mouth of a user. The ventilating mouthguard device includes a base plate, an on/off switch, a power supply and a fan. The kit includes the un-interconnected elements of the device. The method includes the steps of applying, coupling, covering, curing, mixing, mounting, obtaining, preparing, removing, selecting, and turning.

In view of the foregoing disadvantages inherent in the known type mouthguard devices now present in the prior art, the present invention provides an improved ventilating mouthguard device, which will be described subsequently in great detail, is to provide a new and improved ventilating mouthguard device which is not anticipated, rendered obvious, suggested, or even implied by the prior art, either alone or in any combination thereof.

To attain this, the present invention essentially comprises a base plate, an on/off switch, a power supply and a fan.

There has thus been outlined, rather broadly, the more important features of the invention in order that the detailed description thereof that follows may be better understood, and in order that the present contribution of the art may be better appreciated.

The invention may also include an optional keeper strap, an optional flow control switch and an optional extension tube.

Numerous aspects, features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an aspect of the present invention to provide a new and improved ventilating mouthguard device that has many of the advantages of the prior mouthguard device and minimizing a number of their disadvantages.

It is another aspect of the present invention to provide a new and improved ventilating mouthguard device that may be easily and efficiently manufactured and marketed.

An even further aspect of the present invention is to provide a new and improved ventilating mouthguard device that has a low cost of manufacture with regard to both materials and labor, and which accordingly is then susceptible of low prices of sale to the consuming public, thereby making ventilating mouthguard economically available to the buying public.

Still another aspect of the present invention is to provide a ventilating mouthguard device that provides in the apparatuses and methods of the prior art some of the advantages thererof, while simultaneously overcoming some of the disadvantages normally associated therewith.

Even still another aspect of the present invention is to provide a ventilating mouthguard device having a base plate, an on/off switch, a power supply and a fan.

Still another aspect of the present invention is to provide a kit comprising the un-interconnected elements of the device.

Lastly, it is an aspect of the present invention to provide a new and improved method of using comprising the steps of applying, coupling, covering, curing, mixing, mounting, obtaining, preparing, removing, selecting, and turning

There has thus been outlined, rather broadly, the more important features of the invention in order that the detailed description thereof that follows may be better understood, and in order that the present contribution of the art may be better appreciated.

Numerous other features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other aspects of the invention, along with the various features of novelty that characterize the invention, are pointed out with particularity in the claims annexed to and forming a part of this disclosure. For a better understanding of the invention, its operating advantages and the specific aspects attained by its uses, reference should be had to the accompanying drawings and description matter in which there are illustrated preferred embodiments of the invention.

### BRIEF DESCRIPTION OF THE DRAWINGS

The invention will be better understood and aspects other than those set forth above will become apparent when consideration is given to the following detailed description thereof. Such description makes reference to the annexed drawings wherein:

FIG. 1 depicts a top side perspective view of one embodiment of the mouthguard device constructed in accordance to the principles of the present invention;

FIG. 2 depicts a bottom side perspective view of another embodiment of the present invention;

FIG. 3 depicts a top view of another embodiment of the present invention;

FIG. 4 depicts a bottom view of the embodiment depicted in FIG. 3;

FIG. 5 depicts a side view of another embodiment of the present invention worn in a mouth of a user;

FIG. 6 depicts a partial cross sectional view of yet another embodiment of the present invention;

FIG. 7. depicts a view of an embodiment of a kit of the present invention for use in dental impression.

FIG. 8 depicts a bottom perspective side view of still another embodiment of the present invention being mounted onto a upper portion of a patient's mouth for making a dental impression; and

FIG. 9 depicts a bottom perspective side view of the embodiment of the present invention mounted onto the upper portion of the patient's mouth.

The same reference numerals refer to the same parts throughout the various figures.

### DETAILED DESCRIPTION OF THE PREFERRED EMBODIMENT

The following detailed embodiments of the present invention presented herein are for illustrative purposes. That is, these detailed embodiments are intended to be exemplary of the present invention for the purposes of providing and aiding a person skilled in the pertinent art to readily understand how to make and use of the present invention.

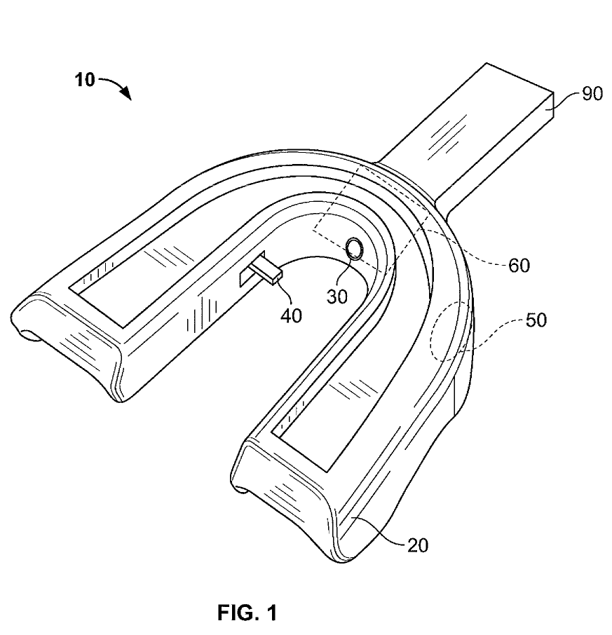

Referring now to the drawings, and in particular FIGS. 1 to 9 thereof, one preferred embodiment of the present invention is shown and generally designated by the reference numeral 10. One embodiment of the ventilating mouthguard device 10 comprises a base plate 20, an on/off switch 40, a power supply 50 and a fan 60. The base plate 20 has an air passageway 30 traversing thought the base plate 20. The on/off switch 40 is electrically coupled to the power supply 50 and to the fan 60. The fan 60 is attached to the base plate 20 in which the fan 60 is in fluid communications with the air passageway 30 of the base plate 20.

The base plate 20 can be any known shape or configuration as long as it is able to be mounted within a mouth 170 of a user 190. One preferred configuration of the base plate 20 is that the base plate 20 has a generally U-shaped configuration shaped to fit around the jaw and teeth of the user 190.

One variant of an embodiment of the device 10 is that the on/off switch 40 is attached directly to the base plate 20. Another variant of an embodiment of the device 10 is that the on/off switch 40 can be connected to the base only by being electrically attached to the fan 60 in which the fan 60 is attached to the base plate 20.

One variant of an embodiment of the device 10 is that the power supply 50 can be attached to the base plate 20. Yet another variant of an embodiment of the device 10 is that the power supply 50 is not directly attached to the device 10 but rather electrically attached to the fan 60. The power supply 50 can be any known type of power supply 50, such as an electrical plug that can be coupled to an electrical wall socket. A preferred embodiment of the power supply 50 is that it is a battery power supply 50 so that the device 10 can be a stand alone device 10 independent of any stationary positioned power supply 50.

An optional keeper strap 70 can be added to the device 10 in which the keeper strap 70 is attached to the base plate 20.

An optional flow control switch 80 can be added to the device 10 in which the flow control switch 80 is electrically coupled to the on/off switch 40.

An optional extension tube 90 can be added to the device 10 in which the extension tube 90 is attached to the base plate 20 so that the extension tube 90 is in fluid communications with the air passageway 30. The optional extension tube 90 can even be configured to hold any number of therapeutic medications in which the therapeutic medications can be subsequently blown into the air passageway of the device.

An optional control circuit 100 can be added to the device 10 in which the control circuit 100 is electrically coupled to the on/off switch 40. One variation of an embodiment of the device 10 is that the control circuit 100, the on/off switch 40, and the power supply 50 are all attached to the base plate 20.

One preferred embodiment of the kit 110 for a ventilating mouthguard device 10 comprises a base plate 20, an on/off switch 40, a power supply 50, and a fan 60. The base plate 20 has an air passageway 30 traversing thought the base plate 20. The on/off switch 40 is electrically coupleable the power supply 50 and to the fan 60. The fan 60 is attached to the base plate 20 in which the fan 60 is in fluid communications with the air passageway 30 of the base plate 20.

An optional ultraviolet light source 120 can be added to the kit 110 in which the ultraviolet light source 120 is for accelerating curing of the setting resin 180.

An optional optical fiber network 130 can be added to the kit 110 in which the optional optical fiber network 130 is attached to the base plate 20.

An optional dental casting resin 140 may be added to the kit 110 in which the optional dental casting resin 140 is for being a major component of the resultant dental impression. One embodiment of the optional dental casting resin 140 is that it is a light curing dental casting resin 140.

An optional hardening agent 150 can be added to the kit 110 in which the hardening agent 150 is for accelerating curing of the setting resin 180.

An optional release agent 160 can be added to the kit 110 in which the optional release agent 160 is for promoting an easier removal of the hardened dental impression away from the patient's mouth 170.

An optional extension tube 90 can be added to the kit 110 in which the optional extension kit 110 is for attaching to the base plate 20 so that the air passageway 30 can be extended further away from the patient's mouth 170. The optional extension tube 90 can even be configured to hold any number of therapeutic medications in which the therapeutic medications can be subsequently blown into the air passageway.

One preferred embodiment of the method of using a ventilating mouthguard device 10 for making a dental impression comprises the steps of applying, coupling, covering, curing, mixing, mounting, obtaining, preparing, removing, selecting, and turning. The obtaining step comprises obtaining a kit 110 comprising: a base plate 20 having an air passageway 30 traversing thought the base plate 20; a on/off switch 40; a power supply 50 electrically coupleable to the on/off switch 40; a fan 60 attached to the base plate 20, wherein the fan 60 is in fluid communications with the air passageway 30 of the base plate 20 and the fan 60 is electrically coupleable to the on/off switch 40; a dental casting resin 140; a hardening agent 150; and a release agent 160. The coupling step comprises coupling electrically together the on/off switch 40 to the power supply 50 and to the fan 60 to assemble the mouthguard device 10. The selecting step comprises selecting an area in a patient's mouth 170 to make the dental impression. The preparing step comprises preparing the selected area of the patient's mouth 170 for the dental impression. The covering step comprises covering teeth in the selected area with a polymer release agent 160. The mixing step comprises mixing together the dental casting resin 140 with the hardening agent 150 to make a setting resin 180. The applying step comprises applying the setting resin 180 onto a portion of the mouthguard device 10. The mounting step comprises mounting the mouthguard device 10 in the patient's mouth 170 so that the setting resin 180 on the mouthguard device 10 contacts a portion of the selected area of the patient's mouth 170. The turning on step comprises turning on the on/off switch 40 to enable the fan 60 to provide additional air to the patient's mouth 170. The step curing comprises curing the setting resin 180 while the mouthguard device 10 is mounted in the patient's mouth 170 and while the fan 60 is enabled to provide additional air to the patient's mouth 170. The removing step comprises removing the mouthguard device 10 from the patient's mouth 170 to retrieve the dental impression from the cured setting resin 180.

In the method when the fan 60 is enabled it pulls air from outside of the patient's mouth 170 through the air passageway 30 of the base plate 20 and into the patient's mouth 170.

Referring now to FIG. 1, a top side perspective view of one embodiment of the mouthguard device 10 is depicted. The mouthguard device 10 is shown having a base plate 20, an on/off switch 40, a power supply 50 and a fan 60. The base plate 20 is shown having an air passageway 30 that traverse all the way thought the base plate 20. The on/off switch 40 is shown mounted on the inside of the mouthguard device 10 so that the fan 60 can be enabled to provide auxiliary air by switching on the on/off switch 40 with a tongue (not shown). The fan 60 is shown attached to the base plate 20 in which the fan 60 is in fluid communications with the air passageway 30 of the base plate 20 so as to convey air from the outside into the air passageway 30 and into the user 190's mouth 170. The fan 60 and the power supply 50 are shown embedded within the mouthguard device 10 so that the mouthguard device 10 can be a stand alone type so that an the wearer can participate in any number of different athletic activities, such as boxing, rugby, football, martial arts, handball, basketball, skiing, tennis, cycling and alike.

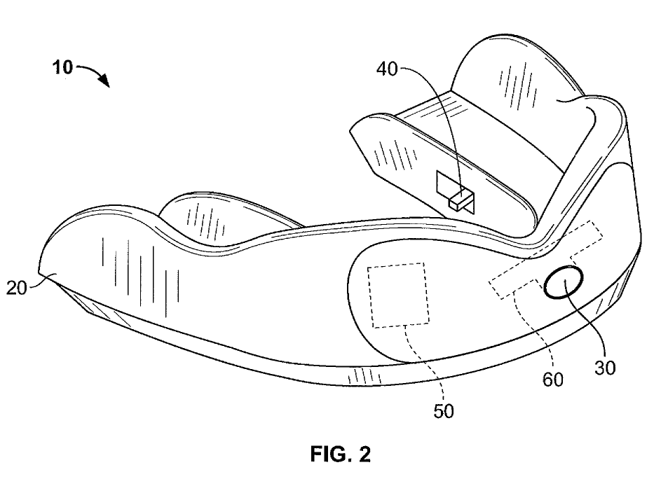

Referring now to FIG. 2, a bottom side perspective view of another embodiment of the mouthguard device 10 is depicted. The ventilating mouthguard device 10 is shown having a base plate 20, an on/off switch 40, an embedded power supply 50 and an embedded fan 60. The base plate 20 is shown having an air passageway 30 traversing all the way thought the base plate 20 such that the fan 60 is in fluid communications with the air passageway 30 of the base plate 20. The on/off switch 40 is electrically coupled to the power supply 50 and to the fan 60. The fan 60 is attached to the base plate 20 in which the fan 60 is in fluid communications with the air passageway 30 of the base plate 20. Also shown is an optional extension tube 90 that can be added to the device 10 in such a way so that the extension tube 90 is in fluid communications with the air passageway 30.

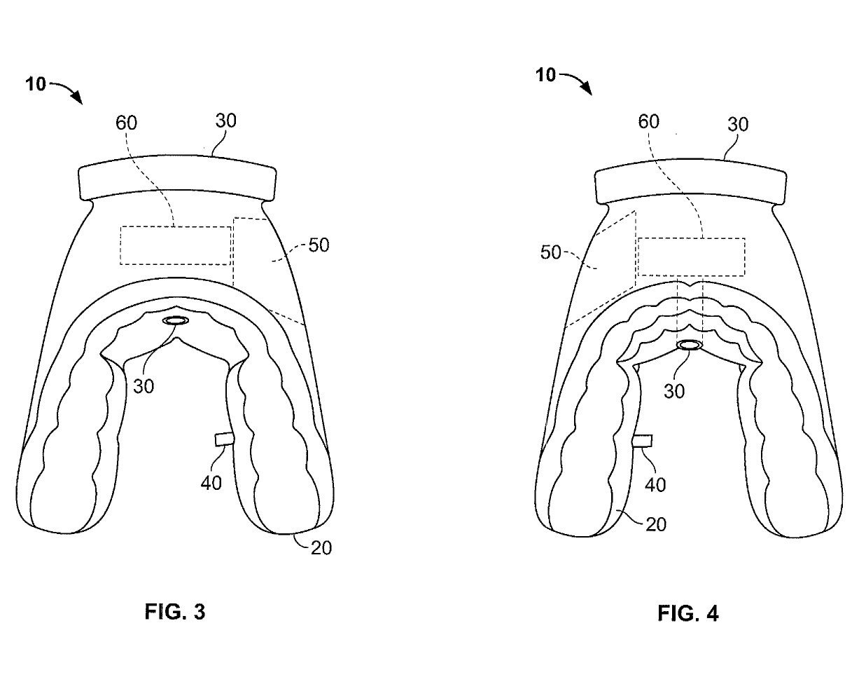

Referring now to FIG. 3, a top view of another embodiment the mouthguard device 10 is depicted. The mouthguard device 10 is shown having a base plate 20, an internally mounted on/off switch 40, an embedded power supply 50 and an embedded fan 60. The base plate 20 is also shown having an air passageway 30 that traverses all the way thought the base plate 20 wherein the embedded fan 60 is configured to be in fluid communications with the air passageway 30 of the base plate 20 so that it can pump air from the outside into the air passageway 30 and into the user 190's mouth 170.

Referring now to FIG. 4, a bottom view of the embodiment the mouthguard device 10 is depicted, as in FIG. 3. The mouthguard device 10 is shown having a base plate 20, an internally mounted on/off switch 40, an embedded power supply 50 and an embedded fan 60. The base plate 20 is also shown having an air passageway 30 that traverses all the way thought the base plate 20 wherein the embedded fan 60 is configured to be in fluid communications with the air passageway 30 of the base plate 20.

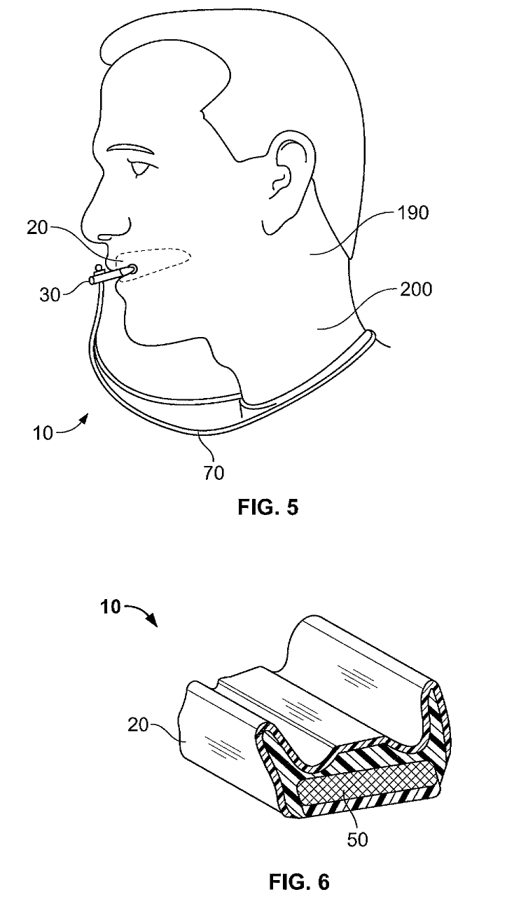

Referring now to FIG. 5, a side view of another embodiment of the mouthguard device 10 worn in a mouth 170 of a user 190. The mouthguard device 10 is shown having a base plate 20 having an air passageway 30 that traverses all the way thought the base plate 20. Also shown is the optional keeper strap 70 attached to the mouthguard device 10 in which the keeper strap 70 can be worn around the neck 200 of the user 190.

Referring now to FIG. 6, a partial cross sectional view of yet another embodiment of the mouthguard device 10 worn is depicted. The mouthguard device 10 is shown having a base plate 20 with the power supply 50 embedded within the base plate 20.

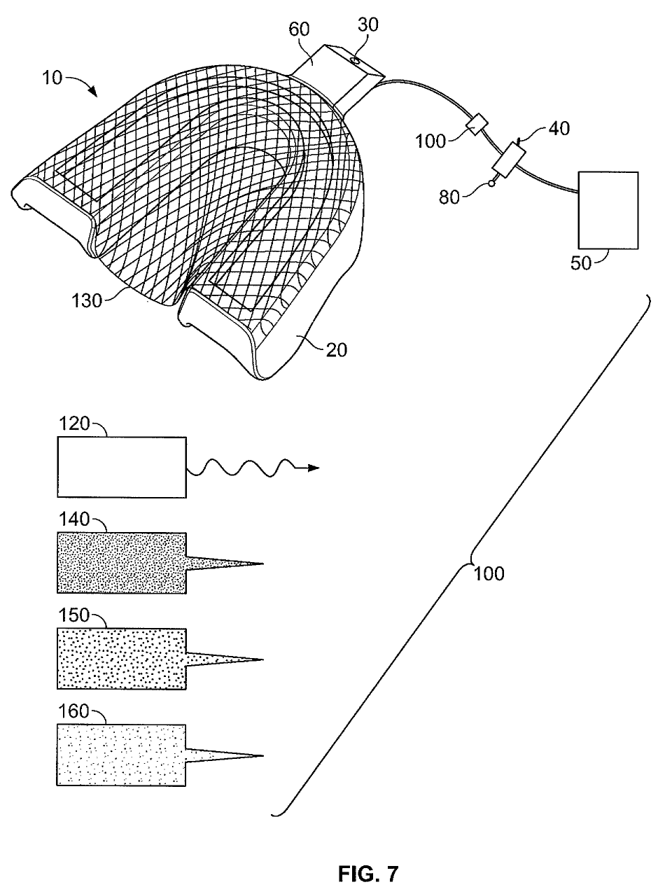

Referring now to FIG. 7, a embodiment of a kit 110 for the mouthguard device 10 for use in dental impression is depicted. The kit 110 is shown having a ventilating mouthguard device 10, a light source 120, a dental casting resin 140, a hardening agent 150, and a release agent 160. ventilating mouthguard device 10 is shown having a base plate 20, an on/off switch 40, a power supply 50, a fan 60, a flow control switch 80, a control circuit 100, and an optical fiber network 130. The fan 60 is shown attached to the base plate 20 in which the air passageway 30 is in fluid communication with the fan 60. The optical fiber network 130 is shown attached to the base plate 20 in which the optical fiber network 130 is for being optically coupled to the light source 120 to aid in accelerating the curing time of the setting resin 180. The on/off switch 40, the power supply 50 the flow control switch 80, the control circuit 100 are shown attached and electrically coupled to one another. The on/off switch 40, the power supply 50 the flow control switch 80, the control circuit 100 are also shown attached to the base plate 20 but not embedded into the base plate 20. The optional light source 120 is shown as a component of the kit 110 in which the light source 120 is for accelerating the curing time of the setting resin 180. The optional dental casting resin 140 is shown as a component of the kit 110 in which the optional dental casting resin 140 is for being a major component of the resultant dental impression. One embodiment of the optional dental casting resin 140 is that it is a light curing dental casting resin 140. The optional hardening agent 150 is shown as a component of the kit 110 in which the hardening agent 150 is for accelerating curing of the setting resin 180. Finally, the optional release agent 160 is shown as a component of the kit 110 in which the optional release agent 160 is for promoting an easier removal of the hardened dental impression away from the patient's mouth 170.

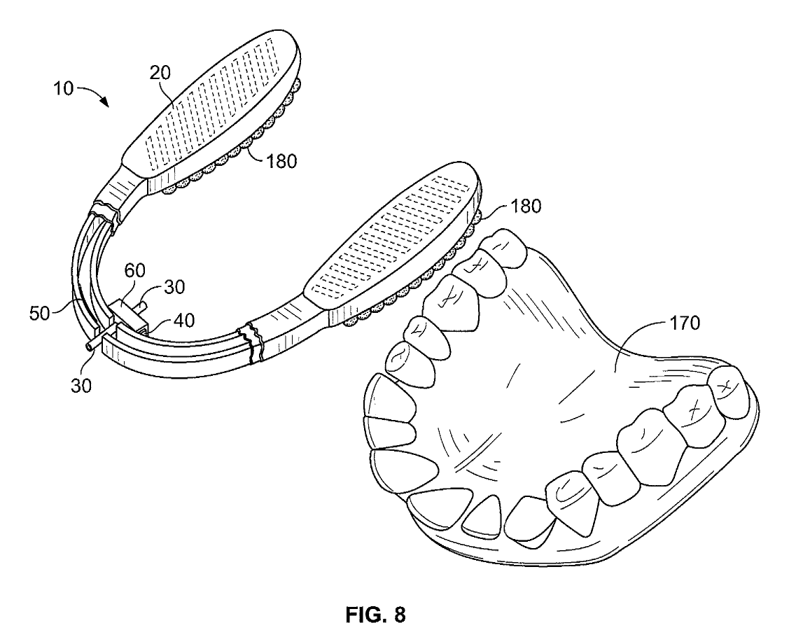

Referring now to FIG. 8, a bottom perspective side view of still another embodiment of the mouthguard device 10 is shown being mounted onto a upper portion of a patient's mouth 170 for making a dental impression. The ventilating mouthguard device 10 is shown having a base plate 20, an internally mounted on/off switch 40, an embedded power supply 50, an embedded fan 60. The fan 60 is shown attached to the base plate 20 in which the air passageway 30 is in fluid communication with the fan 60. Also shown is the setting resin 180 applied onto the mouthguard device 10 in which the setting resin 180 is composed of a mixture of the dental casting resin 140 and the hardening agent 150.

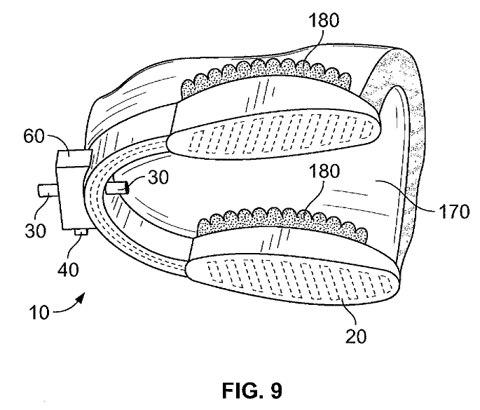

Referring now to FIG. 9, a bottom perspective side view of the embodiment of the mouthguard device 10 is shown mounted onto the upper portion of the patient's mouth 170. The ventilating mouthguard device 10 is shown having a base plate 20, an externally mounted on/off switch 40, an externally mounted fan 60. The fan 60 is shown attached to the base plate 20 in which the air passageway 30 is in fluid communication with the fan 60. Also shown is the setting resin 180 applied onto the mouthguard device 10 in which the setting resin 180 is composed of a mixture of the dental casting resin 140 and the hardening agent 150.

As to the manner of usage and operation of the present invention, the same should be apparent from the above description. Accordingly, no further discussion relating to the manner of usage and operation will be provided.

While a number of preferred embodiments of the ventilating mouthguard device, kit and method of using same have been described in detail, it should be apparent that modifications and variations thereto are possible, all of which fall within the true spirit and scope of the invention.

Further, it should be understood that, although steps of various the claimed method may be shown and described as being in a sequence or temporal order, the steps of any such method are not limited to being carried out in any particular sequence or order, absent an indication otherwise. That is, the claimed method steps are to be considered to be capable of being carried out in any sequential combination or permutation order while still falling within the scope of the present invention.

Furthermore, a person skilled in the art of reading claimed inventions should understand that “a” and “an” each generally denotes “at least one,” but does not exclude a plurality unless the contextual use dictates otherwise. And that the term “or” denotes “at least one of the items,” but does not exclude a plurality of items of the list.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Those skilled in the art will appreciate that the invention described herein is susceptible to variations and modifications other than those specifically described. It is to be understood that the invention includes all such variations and modifications which fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A ventilating mouthguard device comprising:
a base plate having an air passageway traversing thought the base plate;
an on/off switch;
a power supply electrically coupled to the on/off switch; and
a fan attached to the base plate, wherein the fan is in fluid communications with the air passageway of the base plate and the fan is electrically coupled to the on/off switch.

2. The device of claim 1 further comprising a keeper strap attached to the base plate.

3. The device of claim 1 further comprises a flow control switch electrically coupled to the on/off switch.

4. The device of claim 1 further comprising an extension tube attached to the base plate, wherein the extension tube is in fluid communications with the air passageway.

5. The device of claim 1 further comprising a control circuit electrically coupled to the on/off switch.

6. The device of claim 5 wherein the control circuit, the on/off switch, and the power supply are attached to the base plate.

7. The device of claim 1 wherein the base plate having a generally U-shaped configuration.

8. The device of claim 1 wherein the on/off switch is attached to the base plate.

9. The device of claim 1 wherein the power supply is attached to the base plate.

10. The device of claim 9 wherein the power supply is a battery power supply.

11. The device of claim 1 wherein the extension tube can hold therapeutic medications in which the therapeutic medications can be blown into the air passageway of the device.

12. A kit for a ventilating mouthguard device, the kit comprising:
a base plate having an air passageway traversing thought the base plate;
an on/off switch;
a power supply electrically coupleable to the on/off switch; and
a fan attached to the base plate, wherein the fan is in fluid communications with the air passageway of the base plate and the fan is electrically coupleable to the on/off switch.

13. The kit of claim 12 further comprising an ultraviolet light source.

14. The kit of claim 12 further comprising an optical fiber network attached to the base plate.

15. The kit of claim 12 further comprising a dental casting resin.

16. The kit of claim 15 wherein the dental casting resin is a light curing dental casting resin.

17. The kit of claim 12 further comprising a hardening agent.

18. The kit of claim 12 further comprising a release agent.

19. The kit of claim 12 further comprising an extension tube.

20. A method of using a ventilating mouthguard for making a dental impression, the method comprising the steps of:
obtaining a kit comprising:
a base plate having an air passageway traversing thought the base plate;
an on/off switch;
a power supply electrically coupleable to the on/off switch;
a fan attached to the base plate, wherein the fan is in fluid communications with the air passageway of the base plate and the fan is electrically coupleable to the on/off switch;
a dental casting resin;
a hardening agent; and
a release agent;
coupling together the on/off switch to the power supply and to the fan to assemble the mouthguard;
selecting an area in a patient's mouth to make the dental impression;
preparing the selected area of the patient's mouth for the dental impression;
covering teeth in the selected area with a polymer release agent;
mixing together the dental casting resin with the hardening agent to make a setting resin;
applying the setting resin onto a portion of the mouthguard;
mounting the mouthguard in the patient's mouth so that the setting resin on the mouthguard contacts a portion of the selected area of the patient's mouth;
turning on the on/off switch to enable the fan to provide additional air to the patient's mouth;
curing the setting resin while the mouthguard is mounted in the patient's mouth and while the fan is enabled to provide additional air to the patient's mouth; and
removing the mouthguard from the patient's mouth to retrieve the dental impression from the cured setting resin.
